(19) United States
(12) Patent Application Publication
(10) Pub. No.: US 2001/0050448 A1
(43) Pub. Date: Dec. 13, 2001

(54) Three-dimensional modeling apparatus

(75) Inventors: Naoki Kubo, Nishinomiya-Shi (JP); Shigeaki Tochimoto, Osaka (JP)

Correspondence Address: McDERMOTT, WILL & EMERY, 600 13th Street, N.W., Washington, DC, 20005, US

(73) Assignee: Minolta Co., Ltd.

(21) Appl. No.: 09/860,611

(22) Filed: May 21, 2001

(30) Foreign Application Priority Data
May 24, 2000 (JP) P2000-153274

(51) Int. Cl. B29C 31/08

(52) U.S. Cl. 264/308; 425/225; 425/375

(57) ABSTRACT

A three-dimensional modeling apparatus fabricates a 3D object by applying a binding material to a powder material to bind the powder material thereby to form bodies of bound powder material in sequence. The apparatus aims to form layers of uniform thickness at high speed without an increase in size. This apparatus comprises a powder spreader mechanism and a powder supply mechanism. The powder spreader mechanism is movable toward a predetermined travel direction for spreading the powder material along the travel direction to form a layer of the powder material. The powder supply mechanism is configured to move along the travel direction of the powder spreader mechanism for supplying the powder material ahead of the powder spreader mechanism along the travel direction.

This application is based on application No. 2000-153274 filed in Japan, the contents of which are hereby incorporated by reference.

### BACKGROUND OF THE INVENTION

1. Field of the Invention

The present invention relates to a three-dimensional (3D) modeling technique especially for fabricating a 3D object by applying a binding material to bind powder.

2. Description of the Background Art

Conventionally known 3D modeling apparatuses fabricate a 3D object by repeating layer formation and binder application, the layer formation being to spread a powder material in a thin layer over a predetermined stage and the binder application being to apply a binder to predetermined parts of the layer to form a body of bound powder.

The conventional apparatuses are configured such that in formation of a thin layer of powder, the bottom of a powder-retaining powder tank is lifted and a powder material in the powder tank is spread over the stage by a spreader mechanism such as a roller from the side of the stage.

However, the conventional apparatuses require that the powder tank of about the same size as the stage should be located beside the stage for fabrication of a 3D object, thereby having a problem of increase in their sizes as a whole.

Besides, at the time of spreading, powder needs to be spread over the whole surface of the stage from the end of the stage and thus the formed layer of the powder has nonuniform thickness. From this, it is difficult for the conventional apparatuses to form a layer of uniform thickness at high speed.

Furthermore, when a powder material is spread by means of a rotatable roller as a spreader mechanism, powder adhering to the surface of the roller can spill over onto the surface of the spread powder layer, which also causes a problem of surface roughness of such a layer.

### SUMMARY OF THE INVENTION

The present invention is directed to a three-dimensional modeling apparatus for fabricating a three-dimensional object by applying a binding material to a powder material to bind the powder material thereby to form bodies of bound powder material in sequence.

According to an aspect of the present invention, this apparatus comprises: a powder supply mechanism being movable toward a predetermined travel direction for spreading the powder material along the travel direction to form a layer of the powder material; and a powder supply mechanism moving along the travel direction for supplying the powder material ahead of the powder spreader mechanism along the travel direction.

The apparatus can thus be achieved without an increase in size and it can form a layer of uniform thickness at high speed.

According to another aspect of the present invention, this apparatus comprises a powder spreader mechanism being reciprocally movable along a predetermined travel direction for spreading the powder material along the travel direction to form a layer of the powder material; and a powder supply mechanism for supplying the powder material ahead of the powder spreader mechanism in either direction of reciprocating movement of the powder spreader mechanism.

This apparatus can form a layer of the powder material along either direction of the reciprocating movement and therefore can fabricate a three-dimensional object with efficiency.

According to still another aspect of the present invention, this apparatus comprises: a powder spreader mechanism being movable toward a predetermined travel direction for spreading the powder material along the travel direction to form a layer of the powder material; a powder supply mechanism for supplying the powder material ahead of the powder spreader mechanism along the travel direction; and a powder supply varying member for varying a supply of the powder material from the powder supply mechanism according to a thickness of the layer formed by the powder spreader mechanism.

By varying a supply of powder, a three-dimensional object can be fabricated in any desired thickness. This improves the accuracy of modeling of a three-dimensional object and increases the modeling speed.

According to still another aspect of the present invention, this apparatus comprises a powder spreader mechanism for spreading the powder material along a predetermined travel direction by moving a roller toward the travel direction while at the same time, rotating the roller in a predetermined direction, thereby to form a layer of the powder material; and a powder removal member for removing powder adhering to the surface of the roller.

The apparatus can thus prevent surface roughness of the spread powder layer which is caused by powder adhering to the roller surface, thereby allowing the formation of a layer of uniform thickness.

According to still another aspect of the present invention, this apparatus comprises: a powder supply mechanism for supplying the powder material to form a layer of the powder material in a modeling space; a smoothing member for smoothing out the powder material supplied from the powder supply mechanism; the first drive mechanism for driving the powder supply mechanism to scan a plane in the modeling space; a second drive mechanism for driving the smoothing member to scan the plane, following after the powder supply mechanism driven by the first drive mechanism; a binder supply mechanism for supplying the binding material onto the smoothed powder material to represent a section of the three-dimensional object in the plane, following after the smoothing member driven by the second drive mechanism; and a controller for controlling the first drive mechanism, the second drive mechanism, and the binding material supply mechanism to repeat a drive and a supply a required number of times, to generate a three-dimensional object from the powder material bound with the binding material in the modeling space.

The apparatus can thus be achieved without an increase in size and it can form a layer of uniform thickness at high speed.

The present invention is also directed to a three-dimensional modeling method for fabricating a three-dimensional object.

According to an aspect of the present invention, this method fabricates a three-dimensional object from a powder material bound with a binding material in a stepwise fashion, comprising a first step of forming a layer of the powder material and a second step of selectively supplying the binding material to the previously-formed layer of the powder material. The first and the second steps are repeatedly performed to fabricate the 3D object. The first step comprises the steps of supplying the powder material onto a previously-formed layer of the powder material while scanning the previously-formed layer; and smoothing out the supplied powder material to form a layer of the powder material.

This method can produce a layer of uniform thickness at high speed and therefore can fabricate a three-dimensional object with efficiency.

As above described, an object of the present invention is to form a layer of uniform thickness at high speed without an increase in the size of a three-dimensional modeling apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an example of a 3D modeling apparatus according to a preferred embodiment;

FIG. 2 shows a detailed configuration of a thin-layer forming section according to a first preferred embodiment;

FIG. 3 shows an example of powder removal members;

FIGS. 4A and 4B roughly illustrate the operation of a blade for powder removal;

FIG. 5 shows an example of a powder supply varying member;

FIGS. 6A and 6B roughly illustrate the operation of a pressure supply mechanism for adjustment of the supply of a powder material;

FIG. 7 is a flow chart showing the operating procedure of the 3D modeling apparatus;

FIGS. 8A to 8F are schematic diagrams for explaining the operation of the 3D modeling apparatus;

FIG. 9 shows a detailed configuration of a thin-layer forming section according to a second preferred embodiment;

FIG. 10 is a schematic diagram of a thin-layer forming section according to a third preferred embodiment;

FIGS. 11A and 11B are schematic diagrams showing an example of a configuration of a powder supply mechanism according to a fourth preferred embodiment;

FIG. 12 shows an example of a configuration of a vibration generating mechanism; and

FIGS. 13A and 13B are schematic diagrams showing another example of the configuration of the powder supply mechanism according to the fourth preferred embodiment.

### DESCRIPTION OF THE PREFERRED EMBODIMENTS

Hereinbelow, preferred embodiments of the present invention will be set forth in detail with reference to the drawings.

<1. First Preferred Embodiment>

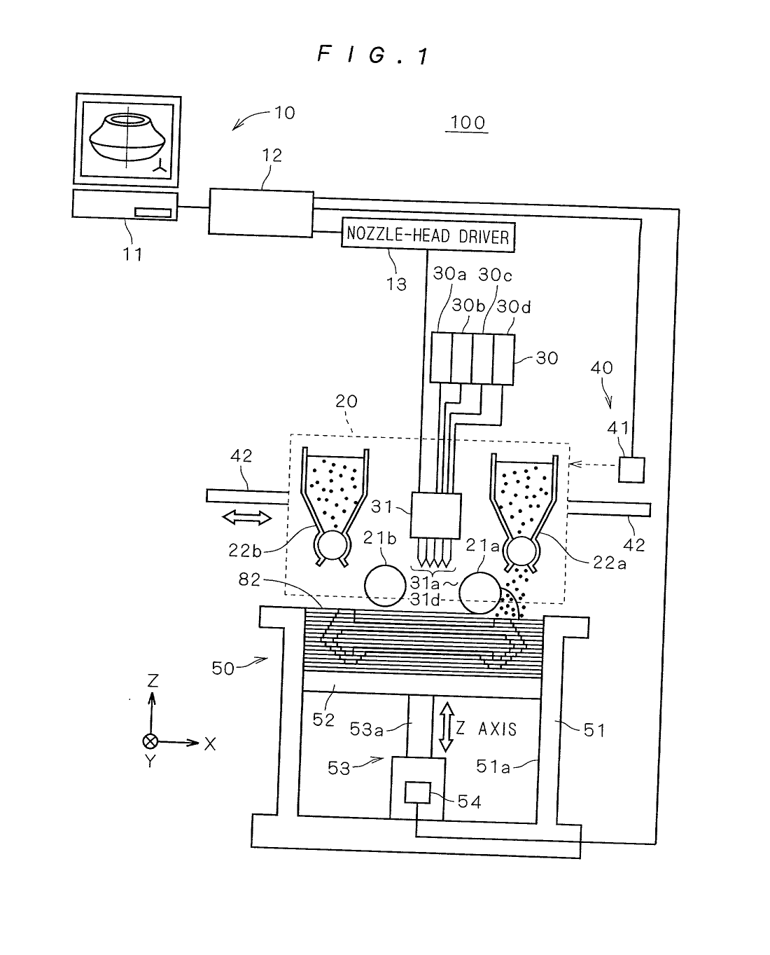

FIG. 1 is a schematic diagram showing an example of a 3D modeling apparatus 100 according to the present invention. The apparatus 100 comprises a control section 10, a thin-layer forming section 20, a binder tank 30, a driver 40 for the thin-layer forming section 20, and a modeling section 50.

The control section 10 comprises a computer 11, a drive controller 12 having an electrical connection to the computer 11, and a nozzle-head driver 13 having an electrical connection to the drive controller 12.

The computer 11 is for example a general desktop computer comprising a CPU, a memory, and the like. The computer 11 converts an object of three-dimensional shape into shape data, and slices the shape data into a plurality of parallel sections to obtain section data for each section, which is then outputted to the drive controller 12.

The drive controller 12 serves as a controller for individually driving the thin-layer forming section 20 and the modeling section 50. Upon receipt of the section data from the computer 11, the drive controller 12 gives a drive command responsive to the section data to each of the above sections for centralized control of the supply and spreading of a powder material in the modeling section 50 to form successive layers of a body of bound powder in the modeling section 50.

The drive controller 12 also designates regions of the powder material to be bound according to the section data and gives the information to the nozzle-head driver 13.

The nozzle-head driver 13 controls a drive to eject binders as binding materials to predetermined regions of the layer surface after each formation of a thin layer of powder material in the thin-layer forming section 20.

The thin-layer forming section 20 comprises a first spreader roller 21a, a second spreader roller 21b, a first powder supply mechanism 22a, a second powder supply mechanism 22b, and a nozzle head 31. The thin-layer forming section 20 is reciprocally movable along the X direction by the driver 40. The spreader rollers 21a, 21b, the powder supply mechanisms 22a, 22b, and the nozzle head 31 are configured to be long in the Y direction so that the formation of a thin layer of powder material and the binding of the powder material with binders in the modeling section 50 can be accomplished in one X-directional operation by the driver 40.

The first powder supply mechanism 22a is located such that it is positioned ahead (i.e., downstream) of the first spreader roller 21a along the direction of travel when the thin-layer forming section 20 moves in the positive X direction. The second powder supply mechanism 22b is located such that it is positioned ahead of the second spreader roller 21b along the direction of travel when the thin-layer forming section 20 moves in the negative X direction.

When the thin-layer forming section 20 moves in the positive X direction, the first spreader roller 21a and the first powder supply mechanism 22a operate; more specifically, the mechanism 22a supplies a powder material ahead of the roller 21a along the travel direction. When the thin-layer forming section 20 moves in the negative X direction, on the other hand, the second spreader roller 21b and the second powder supply mechanism 22b operate; more specifically, the mechanism 22b supplies a powder material ahead of the roller 21b along the travel direction. Drive functions to achieve this will be described later in detail.

The driver 40 for the thin-layer forming section 20 comprises a motor 41 as a drive mechanism and a guide rail 42. By rotatably driving the motor 41 in both forward and reverse directions, the thin-layer forming section 20 reciprocates along a track defined by the guide rail 42 which is installed along the X direction.

The binder tank 30 comprises a plurality of tanks 30a to 30d each containing a liquid binder of a different color component. More specifically, the tanks 30a to 30d contain liquid binders of three primary colors: yellow (Y), magenta (M), and cyan (C), and a liquid binder of white (W), respectively. Preferably, each binder are not discolored on binding with powder and are neither discolored nor faded with time.

The tanks 30a to 30d each have installed therein a tube from which the binder in each tank is individually led into the nozzle head 31.

The nozzle head 31 comprises a plurality of ejection nozzles 31a to 31d extending in the Y direction and is configured to eject (jet) droplets of the above respective color binders from the ejection nozzles 31a to 31d using an ink jet technique, for example.

The ejection nozzles 31a to 31d each employ a multi-nozzle mechanism having a plurality of binder ejection holes arranged along the Y-direction. Of the plurality of binder ejection nozzles, the nozzle-head driver 13 can select those which are necessary for formation of a body of bound powder and individually control binder ejection from the selected nozzles. The binders ejected from the ejection nozzles 31a to 31d will adhere to a powder layer 82 which is formed in the modeling section 50 located opposite the nozzle head 31.

The modeling section 50 comprises a main body 51 having a hollow portion in the middle, a modeling stage 52 located inside the hollow portion of the main body 51, a Z-directional moving section 53 for moving the modeling stage 52 in the Z direction, and a driver 54 for driving the Z-directional moving section 53.

The main body 51 of the modeling section 50 performs a function of providing a work area for fabrication of a 3D object.

The modeling stage 52 is rectangular in XY cross section, having its side faces in contact with a vertical interior wall 51a of the hollow portion of the main body 51. A 3D space of a rectangular parallelepiped formed by the modeling stage 52 and the vertical interior wall 51a of the main body 51 serves as a modeling space for fabrication of a 3D object. More specifically, binders ejected from the ejection nozzles 31a to 31d are used to bind powder on the modeling stage 52, which results in the fabrication of a 3D object.

The Z-directional moving section 53 has a bearing bar 53a coupled to the modeling stage 52. Vertical reciprocating movement of the bearing bar 53a driven by the driver 54 effects Z-directional movement of the modeling stage 52 coupled to the bearing bar 53a.

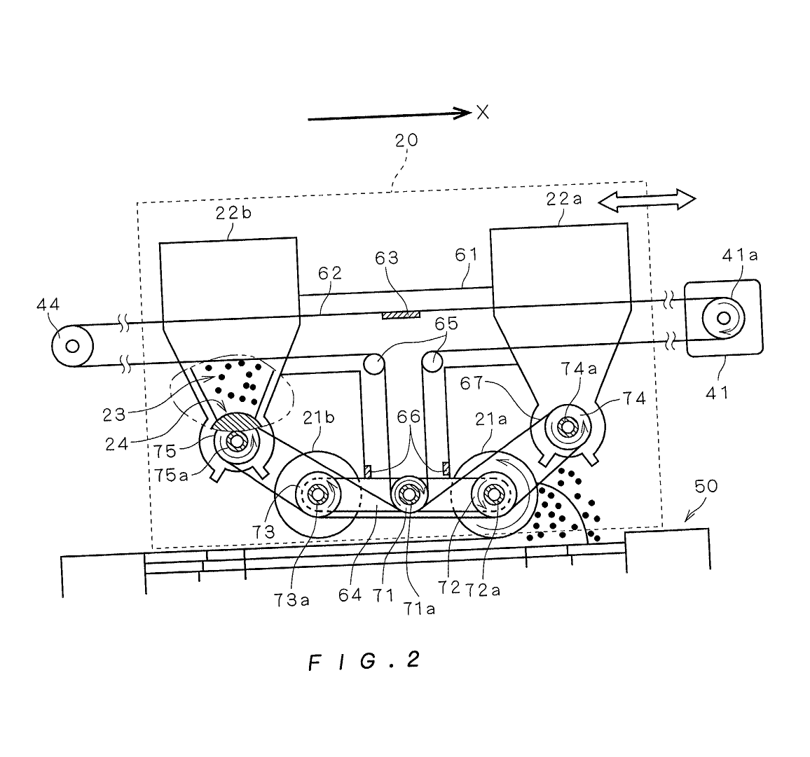

Next, a detailed configuration of the thin-layer forming section 20 will be set forth. FIG. 2 shows a configuration except for the nozzle head 31.

As shown in FIG. 2, the powder supply mechanisms 22a and 22b are fixed to a T-shaped connecting member 61. To transfer the driving force of the motor 41 in the driver 40, the connecting member 61 is fixedly secured by part of a driving belt 62 and a fixing member 63. The driving belt 62 runs around a rotating member 41a of the motor 41 and a pulley 44 located in a predetermined position so that the thin-layer forming section 20 can be moved along the X direction.

In the lower part of the connecting member 61, a freely rotatable pulley 71 is provided which is coupled to an oscillating member 64 through a torque limiter 71a provided in the pulley 71. The driving belt 62 also runs around the pulley 71 through pulleys 65 provided in the connecting member 61.

With this configuration, when the motor 41 rotates in a direction of arrow (clockwise) of FIG. 2, for example, the fixing member 63 for the connecting member 61 is moved to the right (in the positive X direction). This gives a clockwise turning force to the pulley 71, whereby the oscillating member 64 rotates to lower its end on the side of the positive X direction and to raise its end on the side of the negative X direction. In the lower part of the connecting member 61, stoppers 66 are provided at predetermined positions to restrict the oscillating movement of the oscillating member 64. Thus, even if the oscillating member 64 is inclined in only one direction by the turning force given to the pulley 71, the angle of inclination can be restricted to a predetermined angle. After the restriction is placed on the oscillating movement of the oscillating member 64, the driving belt 62 runs the pulley 71 at idle in the clockwise direction by the action of the torque limiter 71a.

When the motor 41 rotates in the opposite direction of the arrow (counterclockwise) of FIG. 2, the fixing member 63 for the connecting member 61 is moved to the left (in the negative X direction). This gives a counterclockwise rotational power to the pulley 71, whereby the oscillating member 64 rotates to lower its end on the side of the negative X direction and to raise its end on the side of the positive X direction. After the restriction is placed on the oscillating movement of the oscillating member 64 by the stoppers 66, the driving belt 62 runs the pulley 71 at idle in the counterclockwise direction by the action of the torque limiter 71a.

The first spreader roller 21a and the second spreader roller 21b are attached to both ends of the oscillating member 64 through pulleys 72, 73 and one-way clutches 72a, 73a.

The first spreader roller 21a is configured such that upon counterclockwise rotation of the pulley 72, the one-way clutch 72a operates to transfer the driving force, while upon clockwise rotation of the pulley 72, the one-way clutch 72a turns idly not to transfer the driving force to the spreader roller 21a.

The second spreader roller 21b is configured such that upon clockwise rotation of the pulley 73, the one-way clutch 73a operates to transfer the driving force, while upon counterclockwise rotation of the pulley 73, the one-way clutch 73a turns idly not to transfer the driving force to the spreader roller 21b.

The upper parts of the powder supply mechanisms 22a and 22b are configured as powder reservoirs 23 to retain a predetermined powder material. In the lower part of each powder reservoir 23, a porous supply roller 24 is provided. Since the supply roller 24 has a porous surface, holes in the surface thereof which are in contact with the powder material in the powder reservoir 23 are filled with that powder material. Such powder in the holes in the roller surface will be led by rotation of the supply roller 24 into an opening which is formed in the lowermost part of the powder supply mechanism 22a or 22b and then the powder material falls through that opening. In this way, the powder material is supplied to the modeling section 50.

To rotate the supply rollers 24 in the powder supply mechanisms 22a and 22b, pulleys 74, 75 and one-way clutches 74a, 75b are coaxially provided in the lower parts of the powder supply mechanisms 22a and 22b, respectively.

Upon counterclockwise rotation of the pulley 74, the one-way clutch 74a operates to transfer the driving force to the supply roller 24 in the first powder supply mechanism 22a, while upon clockwise rotation of the pulley 74, the one-way clutch 74a turns idly not to rotate that supply roller 24.

Upon clockwise rotation of the pulley 75, the one-way clutch 75a operates to transfer the driving force to the supply roller 24 in the second powder supply mechanism 22b, while upon counterclockwise rotation of the pulley 75, the one-way clutch 75b turns idly not to rotate that supply roller 24.

A power transfer belt 67, which is a second driving belt, is looped around the pulleys 71, 72, 73, 74, and 75 to operate in response to rotation of the pulley 71 driven by the driving belt 62.

With the aforementioned configuration, when the motor 41 rotates in the direction of arrow (clockwise) of FIG. 2, for example, the thin-layer forming section 20 moves to the right (in the positive X direction) and the power transfer belt 67 operates. Consequently, the first spreader roller 21a and the supply roller 24 in the first powder supply mechanism 22a rotate counterclockwise. At this time, the second spreader roller 21b and the supply roller 24 in the second powder supply mechanism 22b are at rest.

When the motor 41 rotates in the opposite direction to the arrow (counterclockwise) of FIG. 2, on the other hand, the thin-layer forming section 20 moves to the left (in the negative X direction) and the power transfer belt 67 operates opposite to the direction in the above case. Consequently, the second spreader roller 21b and the supply roller 24 in the second powder supply mechanism 22b rotate clockwise. At this time, the first spreader roller 21a and the supply roller 24 in the first powder supply mechanism 22a are at rest.

Therefore, when the thin-layer forming section 20 moves in the positive X direction, the first spreader roller 21a and the first powder supply mechanism 22a operate such that for formation of a powder layer, the first spreader roller 21a is positioned below the level of the second spreader roller 21b to uniformly spread the powder material which is supplied ahead of the roller 21a along the travel direction. On the other hand, when the thin-layer forming section 20 moves in the negative X direction, the second spreader roller 21b and the second powder supply mechanism 22b operate such that the second spreader roller 21b is positioned below the level of the first spreader roller 21a to uniformly spread the powder material which is supplied ahead of the roller 21b along the travel direction.

The thin-layer forming section 20 of this preferred embodiment further comprises powder removal members which are located in predetermined positions of the spreader rollers 21a and 21b to remove powder from the surfaces of the spreader rollers 21a and 21b. Those powder removal members prevent a powder material which adheres to the surfaces of the spreader rollers 21a and 21b from adhering to the spread powder layer when the powder material is spread in a thin layer ahead of the spreader rollers 21a and 21b with rotation of the spreader rollers 21a and 21b.

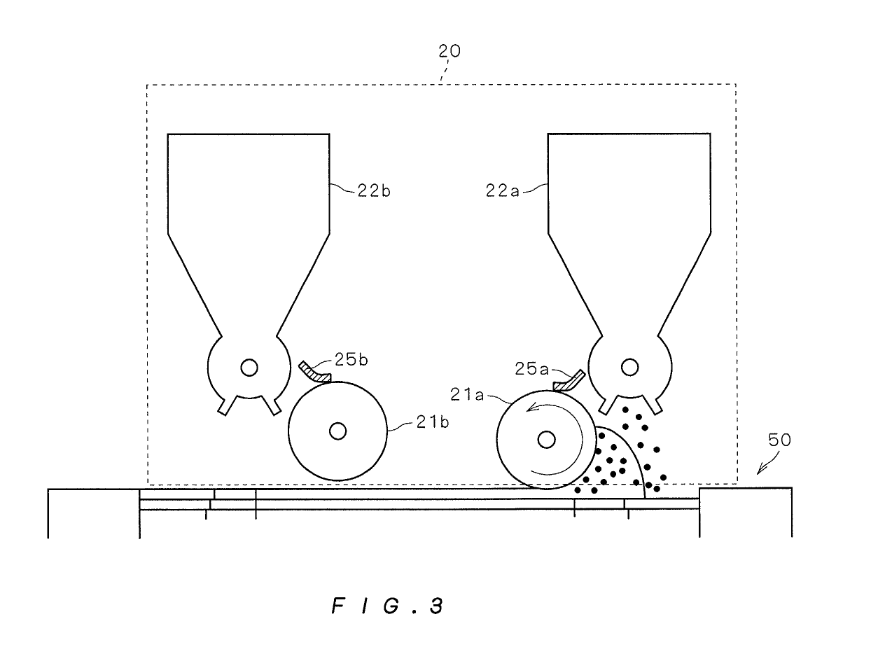

FIG. 3 shows an example of such powder removal members. The aforementioned drive mechanisms and the nozzle head 31 are not shown in FIG. 3. As shown in FIG. 3, the spreader rollers 21a and 21b are provided with blades 25a and 25b, respectively, each of which is formed of an elastic member or the like as a powder removal member. The blades 25a and 25b are located in contact with the surfaces of the spreader rollers 21a and 21b, respectively, and they have lengths as long as or beyond the full lengths of the spreader rollers 21a and 21b extending in the Y direction.

Preferably, the blades 25a and 25b are located in such positions that the powder material which was removed from the surfaces of the spreader rollers 21a and 21b can be resupplied ahead of the spreader rollers 21a and 21b along the travel direction.

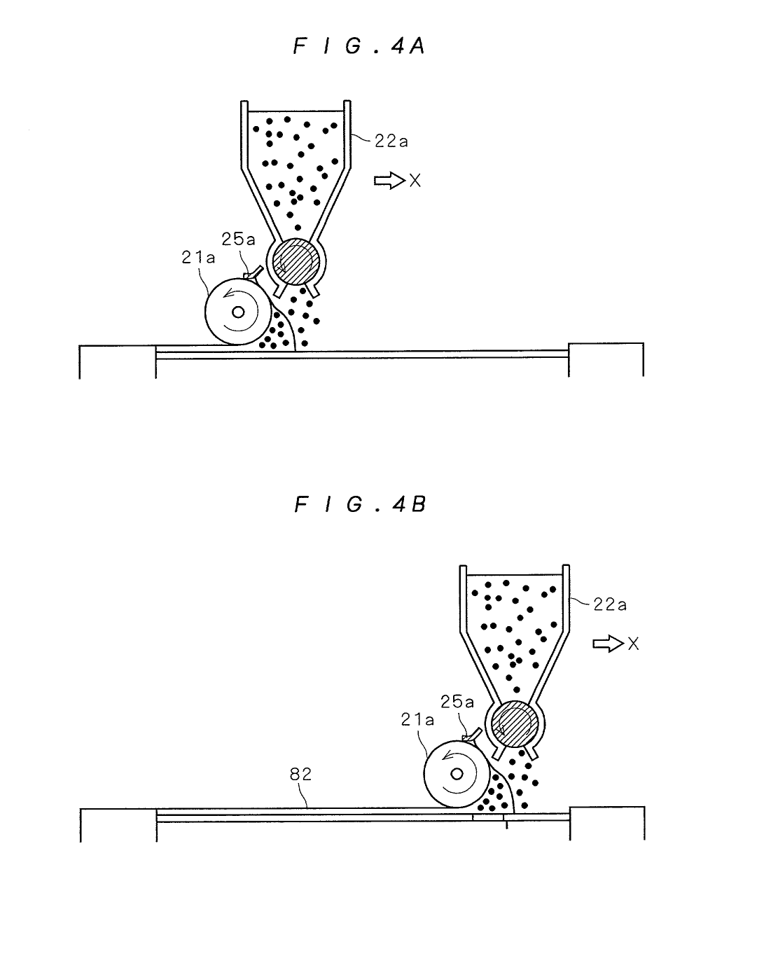

FIGS. 4A and 4B roughly illustrate the operation of the blade 25a for powder removal. First, when the thin-layer forming section 20 moves in the X direction as shown in FIG. 4A, the powder supply mechanism 22a supplies a powder material ahead of the spreader roller 21a along the travel direction. The supplied powder material is uniformly spread in a layer of a predetermined thickness by the spreader roller 21a which rotates counterclockwise in the drawing. At this time, the powder material may be transferred to the surface of the spreader roller 21a, but such a transferred powder material is led to the installation position of the blade 25a with rotation of the spreader roller 21a. The blade 25a then removes the powder material which was transferred to the roller surface and the removed powder material spills over again ahead of the spreader roller 21a along the travel direction. Consequently, even when the X-directional movement of the spreader roller 21a proceeds as shown in FIG. 4B, the transferred powder exerts no influence upon the surface of the spread powder layer 82 and the powder layer 82 is formed with a surface of uniform thickness. The blade 25b also has the same effect as described above.

As above described, since the powder material which adhere to the surface of the spreader roller 21a or 21b is removed by the blade 25a or 25b in spreading the powder material with rotation of the spreader roller 21a or 21b, the powder material will never spill over behind the spreader roller 21a or 21b. This prevents surface roughness of the spread powder layer.

While in this preferred embodiment the blades 25a and 25b are illustrated as powder removal members, the present invention is not limited thereto but brush type powder removal members may be used instead.

The thin-layer forming section 20 of this preferred embodiment further comprises powder supply varying members so that the powder supply mechanisms 22a and 22b can vary a supply of powder material according to the thickness of a single powder layer 82 to be formed on the modeling stage 52 in the modeling section 50.

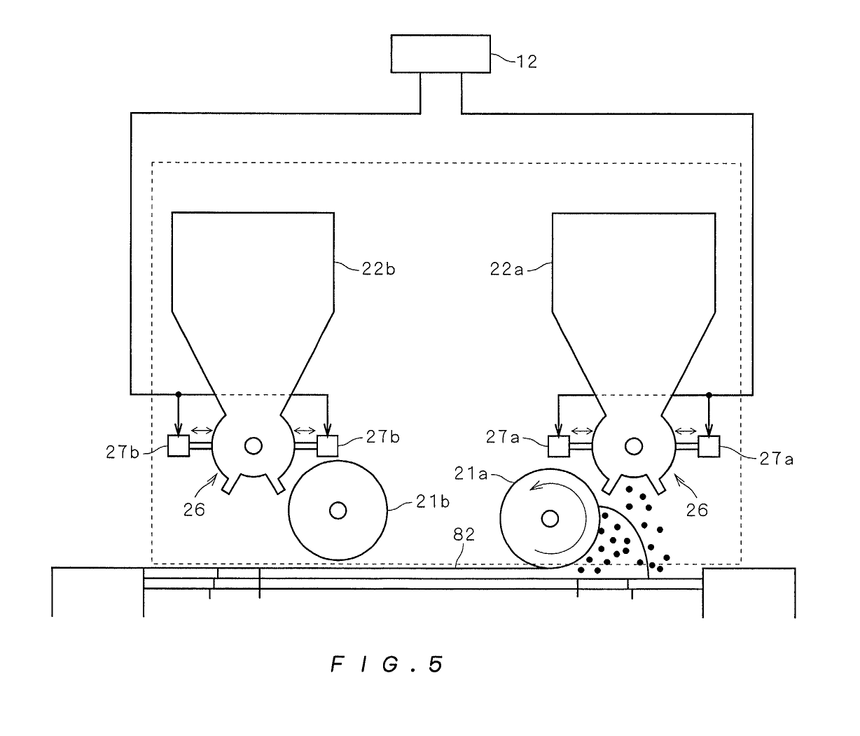

FIG. 5 shows an example of the powder supply varying members. The aforementioned drive mechanisms, the nozzle head 31, and the blades 25a, 25b are not shown in FIG. 5. As shown in FIG. 5, pressure supply mechanisms 27a and 27b are provided to apply external pressure to exterior walls 26 of the powder supply mechanisms 22a and 22b, respectively, where the supply rollers 24 are located. The pressure supply mechanisms 27a and 27b each are constituted by a cylinder mechanism or the like and a drive thereto is controlled by the drive controller 12. By varying pressure applied to the exterior walls 26, the degree of tightening of the supply rollers 24 can be adjusted.

An increase in the degree of tightening of the supply roller 24 by the pressure supply mechanism 27a or 27b reduces the amount of powder entering the holes in the surface of the supply roller 24, thereby reducing the amount of powder material to be supplied to the modeling section 50 per one rotation of the supply roller 24. On the other hand, a decrease in the degree of tightening by the pressure supply mechanism 27a or 27b increases the amount of powder entering the holes in the surface of the supply roller 24, thereby increasing the amount of powder material to be supplied to the modeling section 50 per one rotation of the supply roller 24. Therefore, a supply of powder material can be adjusted by the pressure supply mechanism 27a or 27b adjusting the degree of tightening of the supply roller 24 at a control command from the drive controller 12.

The pressure supply mechanisms 27a and 27b are configured to have lengths as long as or beyond the full lengths of the exterior walls 26 of the powder supply mechanisms 22a and 22b extending in the Y direction, so that it can adjust the degree of tightening uniformly with respect to the Y direction.

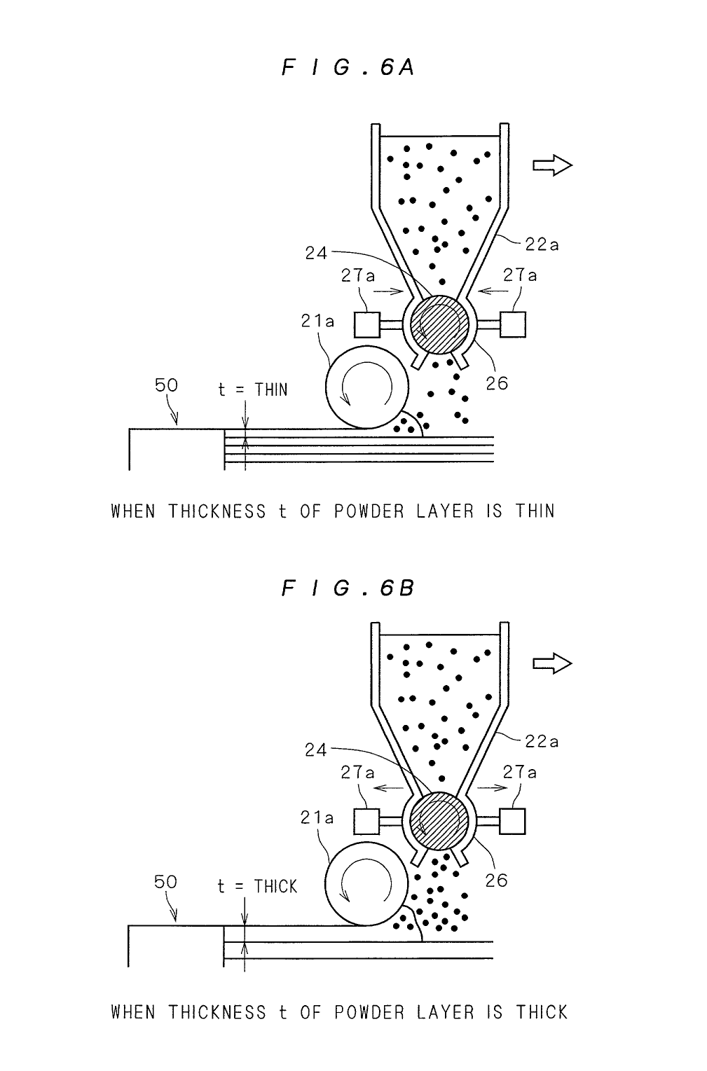

FIGS. 6A and 6B roughly illustrate the operation of the pressure supply mechanism 27a for adjustment of a supply of powder material. Although only the one pressure supply mechanism 27a is shown in FIGS. 6A and 6B, the same applies to the other pressure supply mechanism 27b and thus the description thereof will be omitted hereinbelow.

When the thickness t of a single layer of powder material formed in the modeling section 50 is thin as shown in FIG. 6A, the drive controller 12 gives to the pressure supply mechanism 27a a control command to increase pressure on the exterior wall 26 of the powder supply mechanism 22a according to the layer thickness t. By increasing the pressure on the exterior wall 26 of the powder supply mechanism 22a according to the layer thickness t, the pressure supply mechanism 27a increases the degree of tightening of the supply roller 24. Consequently, the amount of powder material entering the holes in the surface of the supply roller 24 decreases and in turn a supply of powder material to the modeling section 50 increases. In this fashion, a supply of powder can be reduced in the case of thin layer thickness t, which makes it possible to reduce the amount of excess powder material during formation of the powder layer 82.

When the thickness t of a single layer of powder material formed in the modeling section 50 is thick as shown in FIG. 6B, the drive controller 12 give to the pressure supply mechanism 27a a control command to reduce pressure on the exterior wall 26 of the powder supply mechanism 22a according to the layer thickness t. By reducing the pressure on the exterior wall 26 of the powder supply mechanism 22a according to the layer thickness t, the pressure supply mechanism 27a reduces the degree of tightening of the supply roller 24. Consequently, the amount of powder material entering the holes in the surface of the supply roller 24 increases and in turn a supply of powder material to the modeling section 50 increases. In this fashion, a supply of powder can be increased in the case of thick layer thickness t, which makes it possible to avoid shortages of the supply of powder material during formation of the powder layer 82.

In the 3D modeling apparatus 100 of this preferred embodiment with the aforementioned configuration, the thin-layer forming section 20 can reciprocate along the X direction. When the thin-layer forming section 20 moves in the positive X direction, the first powder supply mechanism 22a supplies a powder material ahead of the first spreader roller 21a along the travel direction while moving together with the first spreader roller 21a, maintaining a predetermined relation therebetween. The first spreader roller 21a descends to a predetermined position in order to spread the powder material supplied from the powder supply mechanism 22a for formation of the powder layer 82. At this time, the second spreader roller 21b is held in a floating state above the surface of the powder layer 82 spread by the first spreader roller 21a, in order not to interfere therewith.

When the thin-layer forming section 20 moves in the negative X direction, on the other hand, the second powder supply mechanism 22b supplies a powder material ahead of the second spreader roller 21b along the travel direction while moving together with the second spreader roller 21b, maintaining a predetermined relation therebetween. The second spreader roller 21b descends to a predetermined position in order to spread the powder material supplied from the second powder supply mechanism 22b for formation of the powder layer 82. At this time, the first spreader roller 21a is held in a floating state above the surface of the powder layer 82 spread by the second spreader roller 21b, in order not to interfere therewith.

Next, actual operations of the 3D modeling apparatus 100 of the aforementioned configuration for fabrication of a 3D object will be set forth.

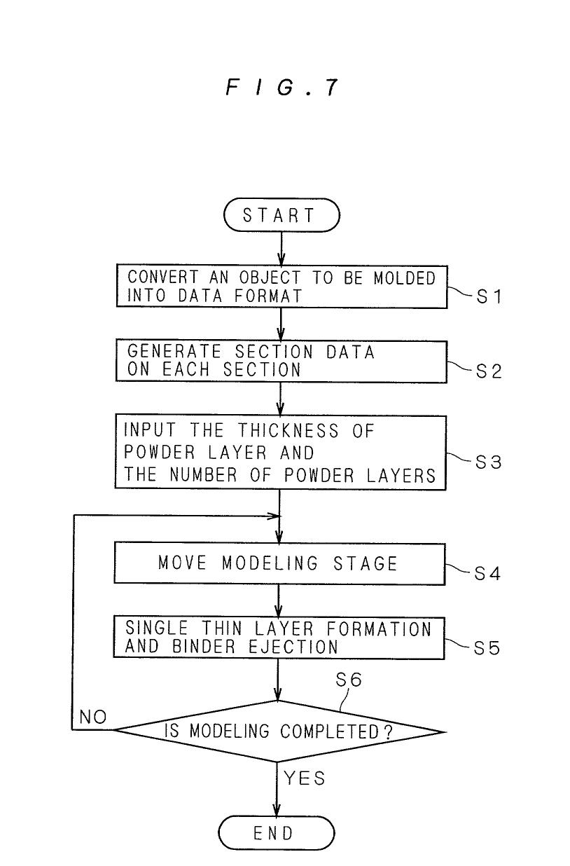

FIG. 7 is a flow chart showing the operating procedure of the 3D modeling apparatus 100. Referring now to the drawing, the basic operation thereof will be described hereinbelow.

In step S1, the computer 11 generates model data which represents an object to be modeled with a color pattern or the like on the surface. As shape data to be the basis for modeling, for example, 3D color model data generated by common 3D CAD modeling software can be used. It is also possible to use shape data and texture obtained by measurement by a 3D-shape input device.

The model data includes two types: those which contain color information about only the surface of a 3D object; and those which contain color information about the interior of a 3D object as well as color information about the surface thereof. In modeling using the latter, only the color information about the 3D object's surface can be used or the color information about both the 3D object's surface and interior can be used. In fabrication of a 3D object such as a human model, for example, it may be required to color the internal organs in different colors, in which case the color information about the 3D object's interior is used.

In step S2, the computer 11 generates section data on each horizontal section of the object to be modeled from the model data. More specifically, from the model data, a horizontal section is sliced off at a pitch (layer thickness t) corresponding to the thickness of a single layer in laminations of powder, thereby to generate shape data and color data. A slice pitch can be changed within the prescribed range (the range of powder thickness that can be bound).

In step S3, information about the thickness of the powder layer (slice pitch in the generation of section data) and the number of powder layers (the number of section data sets) for modeling of a 3D object is transmitted from the computer 11 to the drive controller 12.

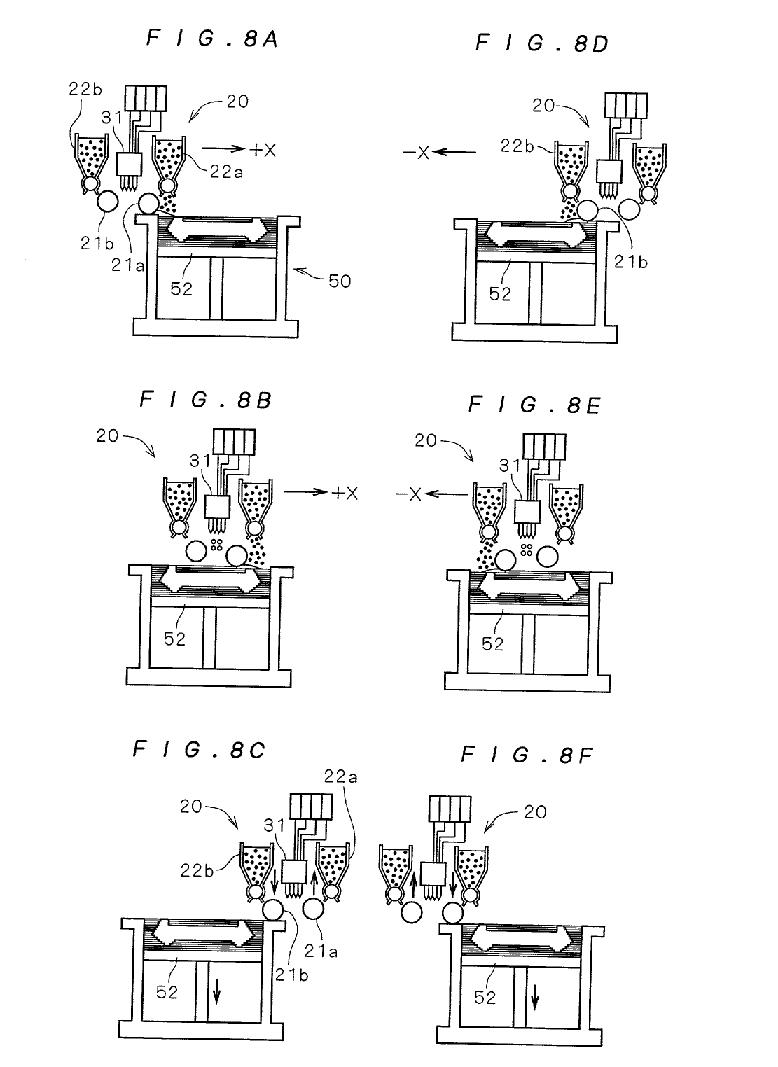

Subsequent steps S4 and later are operations performed under the control of the drive controller 12 and the nozzle-head driver 13. FIGS. 8A to 8F are schematic diagrams illustrating those operations which are hereinbelow described with reference to the drawing.

In step S4, for formation of an N-th layer of a body of bound powder on the modeling stage 52, the modeling stage 52 is lowered by the Z-directional moving section 53 by an amount corresponding to the layer thickness t given by the computer 11 and it is held in that position. In the initial state, the modeling stage 52 is positioned at the same level as the top end of the modeling section 50, from which the modeling stage 52 is lowered by an amount corresponding to the layer thickness t. After formation of each single layer of powder material, the modeling stage 52 is lowered in a stepwise fashion by an amount corresponding to the layer thickness t. Thereby the powder material is deposited on the modeling stage 52 and space to form a new single layer of powder is provided on the bound powder layer which was formed after necessary binder application.

In step S5, the thin-layer forming section 20 is moved along the X direction (either the positive X or negative X direction), whereby powder which is to be a material for modeling of a 3D object is supplied for formation of a single thin layer of powder material and binders are ejected from the nozzle head 31 to predetermined regions for binding and coloring of necessary parts of the powder material.

In the process of moving the powder supply mechanisms 22a and 22b along the X direction, a uniform supply of powder is provided with respect to the Y direction and also the aforementioned drive mechanisms allow a continuous supply of powder with respect to the X direction on the modeling stage 52.

When the thin-layer forming section 20 moves in the positive X direction as shown in FIGS. 8A and 8B, the first spreader roller 21a descends so that its lowest point is positioned at the same level as the top end of the modeling section 50, in which condition the movement in the positive X direction occurs. This makes accurate the formation of a uniform thin layer of powder material by the first powder supply mechanism 22a and the first spreader roller 21a.

The amount of powder material supplied from the powder supply mechanism 22a or 22b during formation of a single layer (during one travel along the X direction) is set to be slightly larger than that required for formation of a single layer, in order to avoid shortages of powder at any position in modeling space. From this, there is an excess of powder material after formation of each layer, but the excess powder material can be recovered for reuse.

As shown in FIG. 8B, the nozzle head 31 also moves in the positive X direction together with the thin-layer forming section 20 while ejecting binders of different colors from the plurality of ejection nozzles onto the spread powder layer on the basis of a control signal from the nozzle-head driver 13. At this time, the nozzle-head driver 13 gives to the nozzle head 31 a control signal based on the shape and color data on a section to be laminated, the shape and color data being included in the section data. This allows proper binding and coloring of the powder material for fabrication of a 3D object. Consequently, a body of bound powder is produced. Here, regions of the powder material to which no binder is applied remain independent from each other.

As above described, the 3D modeling apparatus 100 can perform the formation of a thin layer and the binding and coloring of powder using binders in one operation, which allows implementation of an efficient modeling operation.

When the thin-layer forming section 20 reaches a position as shown in FIG. 8C, one scan is completed and thus modeling of a single layer is completed. As necessary, the step of drying the ejected binders may be added.

At the completion of modeling of a single layer, the process proceeds to step S6 wherein on the basis of the number of layers given in step S3, the drive controller 12 determines whether or not all processing as many as the number of layers is completed (i.e., whether the modeling of a 3D object is completed). If the answer to step S6 is NO, the processing from step S4 is repeated, while if the answer is YES, the modeling operation is completed. At the completion of the modeling of a 3D object, the independent regions of the powder material to which no binder is applied are separated to take out a body of bound powder (3D object) which was bound with the binders. The unbound powder material may be recovered for reuse.

When the process returns to step S4, on the other hand, another operation is performed to form a new (N+1)th layer of body of bound powder on the N-th layer. At this time, if the 3D modeling apparatus 100 is in such a condition as shown in FIG. 8C, the thin-layer forming section 20 starts to move in the negative X direction and the first spreader roller 21a ascends with a descent of the second spreader roller 21b. As shown in FIGS. 8D and 8E, along with the movement of the thin-layer forming section 20 in the negative X direction, the second powder supply mechanism 22b and the second spreader roller 21b performs formation of a powder layer and the nozzle head 31 performs binder ejection. When the thin-layer forming section 20 reaches a position as shown in FIG. 8F, one scan is completed and thus the modeling of another single layer is completed.

In this fashion, the operations depicted in FIGS. 8A to 8F are repeated as many times as the number of layers to be laminated. Thereby successive layers of colored body of bound powder are formed on the modeling stage 52, which results in the production of a final 3D object on the modeling stage 52.

As so far described, the 3D modeling apparatus 100 of this preferred embodiment is configured such that the spreader rollers 21a and 21b can move along the X direction to spread a powder material in either the positive or the negative X direction for formation of a powder layer, and that the powder supply mechanisms 22a and 22b are provided to supply a powder material ahead of the spreader rollers 21a and 21b, respectively, along the travel direction, i.e., either the positive or the negative X direction. Thus, there is no need to provide a powder tank besides the modeling stage as in the conventional apparatus, which reduces the size of the apparatus as a whole. Further, the apparatus 100 of this preferred embodiment is configured to supply a proper amount of powder material ahead of the spreader rollers 21a and 21b along the travel direction, instead of spreading powder over the whole surface of the modeling stage from the end of the stage as in the conventional apparatus. This increases the speed of forming a powder layer of uniform thickness.

The 3D modeling apparatus 100 is also configured such that the powder supply mechanisms 22a and 22b provide a continuous supply of powder material along the travel direction of the thin-layer forming section 20. This will produce a powder layer of a more uniform thickness at high speed.

The powder supply mechanisms 22a and 22b are configured to receive the driving force from the motor 41 which is a drive mechanism for moving the thin-layer forming section 20 including the spreader rollers 21a and 21b in the travel direction, and to provide a supply of powder material in response to the operation of the motor 41 by using the driving force of the motor 41. There is thus no need to provide an additional drive mechanism for powder supply, which allows a further reduction in the size of the 3D modeling apparatus 100. Further, since the drive controller 12 only needs to gives a control command to the motor 41 in controlling that drive mechanism, a complicated control operation is unnecessary. The control operation can thus be simplified.

The 3D modeling apparatus 100 can perform bidirectional thin-layer formation and powder binding when moving the thin-layer forming section 20 reciprocally along the X direction and therefore can fabricate a 3D object with efficiency.

Since a supply of powder from the powder supply mechanisms 22a and 22b can be changed according to the thickness of a powder layer, a 3D object of any layer thickness can be fabricated. This improves the accuracy of modeling of a 3D object and increases the modeling speed.

Further in the 3D modeling apparatus 100 of this preferred embodiment, a powder spreader mechanism for spreading of powder is configured of the spreader rollers 21a and 21b and powder removal members such as the blades 25a and 25b are provided to remove powder adhering to the surfaces of the spreader rollers 21a and 21b. This prevents powder which adheres to the surfaces of the spreader rollers 21a and 21b from spilling over onto the surface of the spread powder layer, thereby permitting the formation of a powder layer of uniform thickness.

<2. Second Preferred Embodiment>

Next, a second preferred embodiment according to the present invention will be set forth. The above first preferred embodiment has provided an example of a configuration wherein the powder supply mechanisms 22a and 22b change the degree of tightening of their respective supply rollers 24 to adjust a supply of powder. On the other hand, this preferred embodiment provides another example of a configuration wherein a supply of powder is adjusted by changing the rotational speed of the supply rollers 24 according to the layer thickness. The overall configuration and general operation of the 3D modeling apparatus 100 according to this preferred embodiment are identical to those described in the first preferred embodiment.

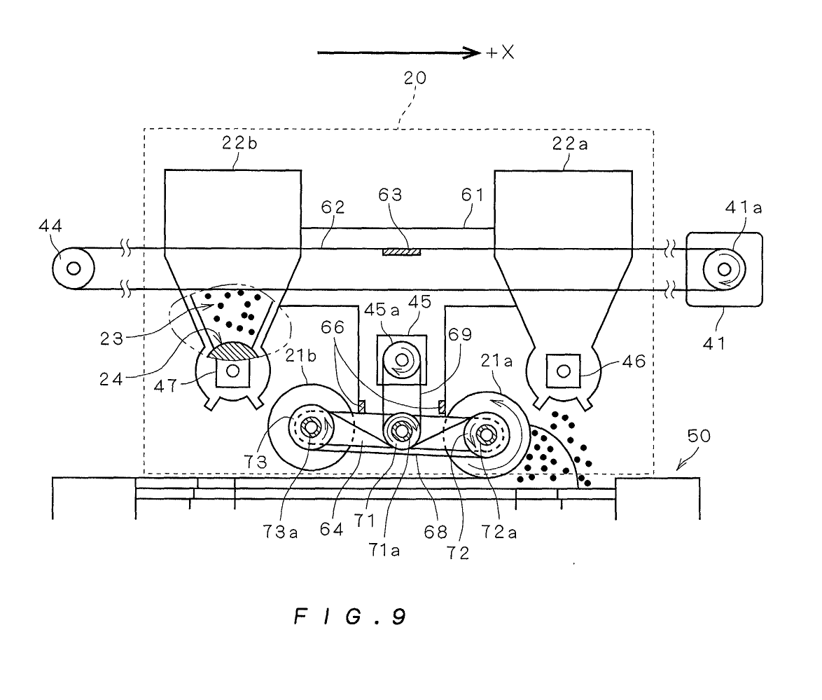

FIG. 9 shows a detailed configuration of the thin-layer forming section 20 according to the second preferred embodiment, except for the nozzle head 31 and the powder removal mechanisms. Herein, like components are denoted by the same reference numerals and characters as used in the first preferred embodiment and a detailed description thereof will be omitted.

As shown in FIG. 9, the powder supply mechanisms 22a and 22b are fixed to the T-shaped connecting member 61. The connecting member 61 is fixedly secured by part of the driving belt 62 and the fixing member 63 to transfer the driving force of the motor 41 in the driver 40. The driving belt 62 runs around the rotating member 41a of the motor 41 and the pulley 44 located in a predetermined position. The connecting member 61 is thus movable along the X direction by the motor 41.

In the central part of the connecting member 61, a motor 45 is provided to drive the spreader rollers 21a and 21b. The motor 45 is rotatable in both clockwise and counterclockwise directions. In the lower part of the connecting member 61, the freely rotatable pulley 71 is provided which is coupled to the oscillating member 64 through the torque limiter 71a provided in the pulley 71. Further, a driving belt 69 runs around a pulley 45a and the pulley 71 to transfer the driving force of the motor 45.

For example, when the motor 45 rotates in a direction of arrow (clockwise) of FIG. 9, a clockwise rotational power is transferred to the pulley 71 and thereby the oscillating member 64 rotates to lower its end on the side of the positive X direction and to raise its end on the side of the negative X direction. The oscillating member 64 will come to a stop at positions restricted by the stoppers 66 as above described. After the oscillating movement of the oscillating member 64 is restricted, the driving belt 69 runs the pulley 71 at idle in the clockwise direction by the action of the torque limiter 71a.

When the motor 45 rotates in the opposite direction of the arrow (counterclockwise) of FIG. 2, a counterclockwise rotational power is transferred to the pulley 71 and thereby the oscillating member 64 rotates to lower its end on the side of the negative X direction and to raise its end on the side of the positive X direction. After the oscillating movement of the oscillating member 64 is restricted by the stoppers 66, the driving belt 69 runs the pulley 71 at idle in the counterclockwise direction by the action of the torque limiter 71a.

Around the pulleys 72 and 73 respectively in the spreader rollers 21a and 21b and the pulley 71, a driving belt 68 runs, which operates in response to rotation of the pulley 71 driven by the driving belt 69.

That is, the motor 45 is configured such that the operations of the spreader rollers 21a and 21b described in the first preferred embodiment can be accomplished by an independent drive mechanism. The rotational direction and speed of the motor 45 is controlled by the drive controller 12.

The powder supply mechanisms 22a and 22b are provided with motors 46 and 47, respectively, to rotate their respective internal supply rollers 24. The rotational speeds of those motors 46 and 47 are controlled by the drive controller 12.

In the 3D modeling apparatus 100 of this preferred embodiment, when the thin-layer forming section 20 moves in the positive X direction for thin-layer formation, the drive controller 12 gives to the motor 41 a drive command to conduct a clockwise drive and also gives individual drive commands to the motors 45 and 46. The apparatus 100 can thus spread powder by means of the first spreader roller 21a while at the same time, supplying powder from the first powder supply mechanism 22a. At this time, the second spreader roller 21b is at rest and the supply of powder from the second powder supply mechanism 22b is at a stop.

When the thin-layer forming section 20 moves in the negative X direction for thin-layer formation, on the other hand, the drive controller 12 give to the motor 41 a drive command to conduct a counterclockwise drive and also gives individual drive commands to the motors 45 and 47. The apparatus 100 can thus spread powder by means of the second spreader roller 21b while at the same time, supplying powder from the second powder supply mechanism 22b. At this time, the first spreader roller 21a is at rest and the supply of powder from the first powder supply mechanism 22a is at a stop.

To change the thickness t of a single layer to be formed, the drive controller 12 sets the amount of descent of the modeling stage 52 according to the layer thickness t for the Z-directional moving section 53 and also changes the rotational speeds of the motors 46 and 47 respectively in the powder supply mechanisms 22a and 22b according to the layer thickness t. Thereby a supply of powder from the porous supply roller 24 to the modeling section 50 is changed, which in turn changes the thickness of a powder layer to be formed on the modeling stage 52.

In this fashion, the 3D modeling apparatus 100 of this preferred embodiment is configured to adjust the rotational speed of the supply roller 24 in the powder supply mechanism 22a or 22b as a powder supply varying member, for adjustment of a supply of powder according to the layer thickness.

This simplifies the configuration of the apparatus and reduces the size thereof as compared with the apparatus provided with the pressure supply mechanisms as described in the first preferred embodiment. In the first preferred embodiment, the supply roller 24 always rotates at a constant speed when a supply of powder is adjusted by means of the pressure supply mechanism; therefore, it is difficult to reduce or increase a supply of powder to more than a certain amount even by increasing or decreasing the degree of tightening of the supply roller 24. On the contrary, if a supply of powder is adjusted by adjusting the rotational speed of the supply roller 24 as in this preferred embodiment, the range of adjustment for powder supply can be increased than when using the pressure supply mechanism for adjustment.

In the thin-layer forming section 20 of this preferred embodiment, the motor 41 for effecting X-directional movement, the motor 45 as a drive mechanism for the spreader rollers 21a and 21b, and the motors 46, 47 as drive mechanisms for individual drives to the powder supply mechanisms 22a and 22b are independent from each other. The drive controller 12 can thus individually control the rotational speeds and the like of such motors, which increases the accuracy of thin-layer formation.

<3. Third Preferred Embodiment>

Next, a third preferred embodiment according to the present invention will be set forth. The above preferred embodiments have provided examples of configuration wherein the two powder supply mechanisms 22a and 22b are located to provide a proper supply of powder during reciprocating movements of the thin-layer forming section 20 in both directions. On the other hand, this preferred embodiment provides an example of a configuration wherein only one powder supply mechanism produces a proper supply of powder in both the directions.

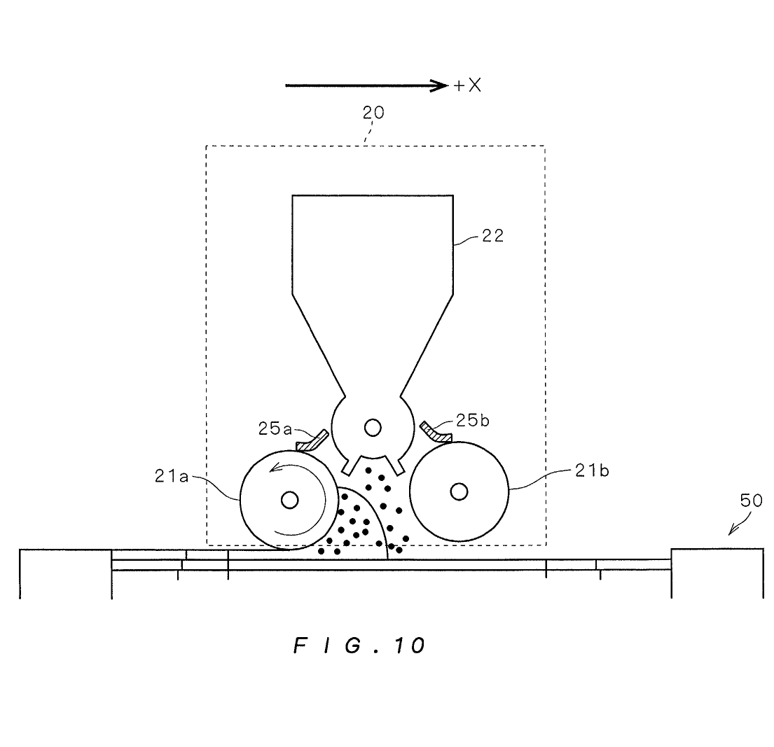

FIG. 10 is a schematic diagram of the thin-layer forming section 20 according to this preferred embodiment. As shown in FIG. 10, the thin-layer forming section 20 of this preferred embodiment is provided with one powder supply mechanism 22 which is located between the first spreader roller 21a and the second spreader roller 21b. The first spreader roller 21a is a powder spreader mechanism for spreading a powder material upon positive X-directional movement of the thin-layer forming section 20 for thin-layer formation, while the second spreader roller 21b is a powder spreader mechanism for spreading a powder material upon negative X-directional movement of the thin-layer forming section 20 for thin-layer formation. The powder supply mechanism 22 has the function of supplying a powder material ahead of the active spreader roller 21a or 21b along the travel direction, irrespective of whether it moves in the positive or the negative X direction.

The spreader rollers 21a and 21b can adopt the same drive mechanisms as described in the second preferred embodiment, for example. However, since the relative positions of the spreader rollers 21a and 21b are different from those in the second preferred embodiment, the form of looping the driving belt 68 needs to be changed in the case of FIG. 9. The powder supply mechanism 22 is configured such that its internal supply roller can be rotated at any rotational speed by an individual motor or the like.

The spreader rollers 21a and 21b are provided with the blades 25a and 25b, respectively, which are powder removal members. Those blades 25a and 25b prevent a powder material from spilling over onto the surface of the spread powder layer upon rotation of the roller.

In the aforementioned configuration, when the thin-layer forming section 20 of this preferred embodiment moves in the positive X direction, the first spreader roller 21a descends to a predetermined spreading position while the second spreader roller 21b is held in the floating state. Then, the powder supply mechanism 22 supplies a powder material ahead of the first spreader roller 21a along the travel direction. From this, the powder material is continuously supplied ahead of the first spreader roller 21a along the travel direction, i.e., the positive X direction, whereby a thin layer of powder material can be formed in uniform thickness.

When the thin-layer forming section 20 moves in the negative X direction, on the other hand, the second spreader roller 21b descends to a predetermined spreading position while the first spreader roller 21a is held in the floating state. Then, the powder supply mechanism 22 supplies a powder material ahead of the second spreader roller 21b along the travel direction. From this, the powder material is continuously supplied ahead of the second spreader roller 21b along the travel direction, i.e., the negative X direction, whereby a thin layer of powder material can be formed in uniform thickness.

In the thin-layer forming section 20 of this preferred embodiment, as above described, the one powder supply mechanism 22 can produce a continuous supply of powder material ahead of the spreader roller 21a or 21b along the travel direction. This will produce a powder layer of uniform thickness and further simplifies the configuration of the thin-layer forming section 20.

In this preferred embodiment, however, it is difficult to locate the nozzle head 31 for ejecting binders to the spread powder layer in the same position as described in the aforementioned preferred embodiments. It thus becomes necessary to individually drive the nozzle head 31 after each formation of a single layer for ejection of binders to predetermined regions. If binder ejection needs to be completed during one X-directional movement of the thin-layer forming section 20, it is desirable to provide two nozzle heads on both sides of the thin-layer forming section 20 in FIG. 10.

The other components of the 3D modeling apparatus 100 according to this preferred embodiment are identical to those described in the aforementioned preferred embodiments.

<4. Fourth Preferred Embodiment>

Next, a fourth preferred embodiment according to the present invention will be set forth. The above preferred embodiments have provided examples of configurations wherein the porous supply roller 24 is provided in the lower part of each of the powder supply mechanisms 22, 22a, 22b and a predetermined amount of powder material is supplied with rotation of the supply roller 24. This preferred embodiment, on the other hand, gives another form of powder supply.

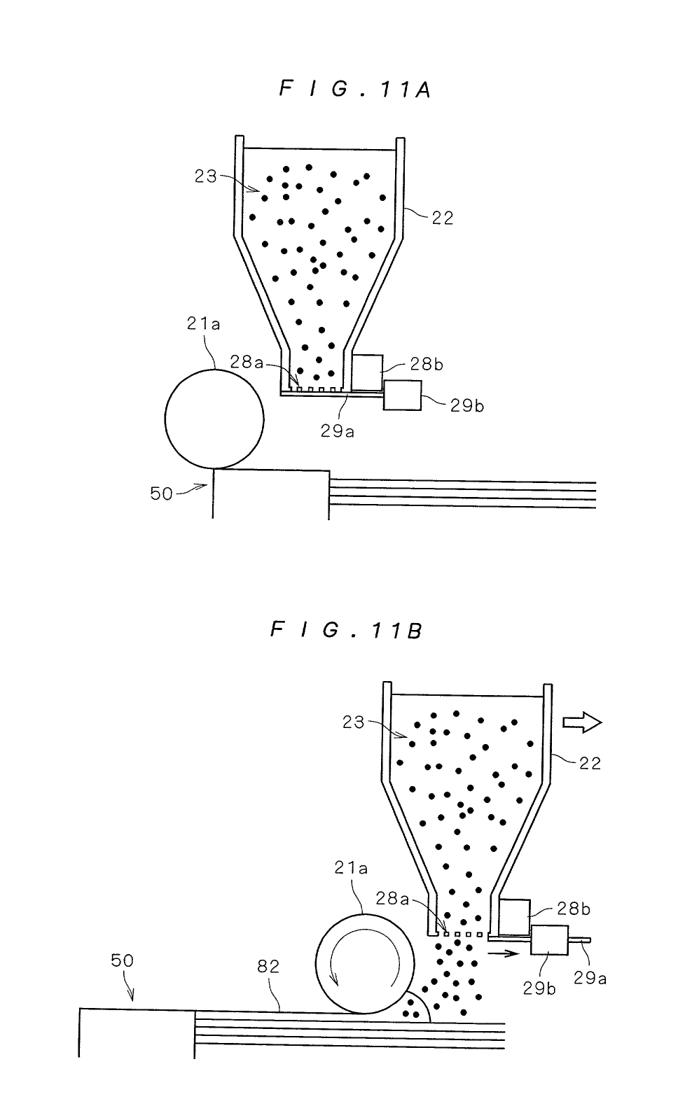

FIGS. 11A and 11B are schematic diagrams of the powder supply mechanism 22 according to this preferred embodiment. As shown in FIG. 11A, a mesh plate 28a with a plurality of holes is provided on the bottom surface side of the powder reservoir 23 in the powder supply mechanism 22. The holes are of such sizes that the power can pass through. In the lower part of the plate 28a, a retractable shutter 29a is provided. The opening and closing of the shutter 29a is done by a shutter driver 29b. Further, a vibration generating mechanism 28b for vibrating the plate 28a is provided on the lower side of the powder supply mechanism 22.

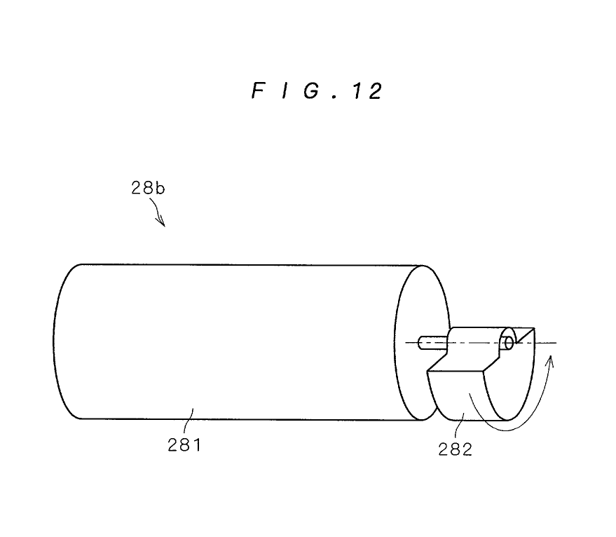

FIG. 12 shows an example of a configuration of the vibration generating mechanism 28b. The vibration generating mechanism 28b comprises a motor 281 and a weight 282. As shown in FIG. 12, the weight 282 is connected to a rotating shaft of the motor 281 in such a manner that the center of gravity of the weight 282 does not coincide with the center of rotation, and rotation of the weight 282 driven by the motor 281 generates vibrations. That is, the vibration generating mechanism 28b is realized by a configuration of a so-called pager motor which is used for example in a vibrating function of cellular phones or the like.

To stop the powder supply from the powder supply mechanism 22 in the aforementioned configuration, the shutter driver 29b drives the shutter 29a to block the bottom surface side of the powder reservoir 23. At this time, the vibration generating mechanism 28b is at rest.

For powder supply, as shown in FIG. 11B, the shutter driver 29b drives the shutter 29a to open the bottom surface side of the powder reservoir 23 and the vibration generating mechanism 28b operates to transmit vibrations to the mesh plate 28a. Consequently, with the vibrations of the mesh plate 28a, the powder material in the powder reservoir 23 is supplied in right amounts to the modeling section 50.

From the above, even if the configuration is such that the mesh plate 28a is provided on the bottom surface side of the powder reservoir 23 in the powder supply mechanism 22 and the vibration generating mechanism 28b is provided to vibrate the mesh plate 28a, a proper supply of powder material can be ensured.

However, when the vibration generating mechanism 28b is attached directly to the side face of the powder supply mechanism 22 as shown in FIGS. 11A and 11B, vibrations are transmitted to the whole powder supply mechanism 22, in which case it can be expected that the vibrations may be absorbed and thereby it may become difficult to supply the right amounts of powder material.

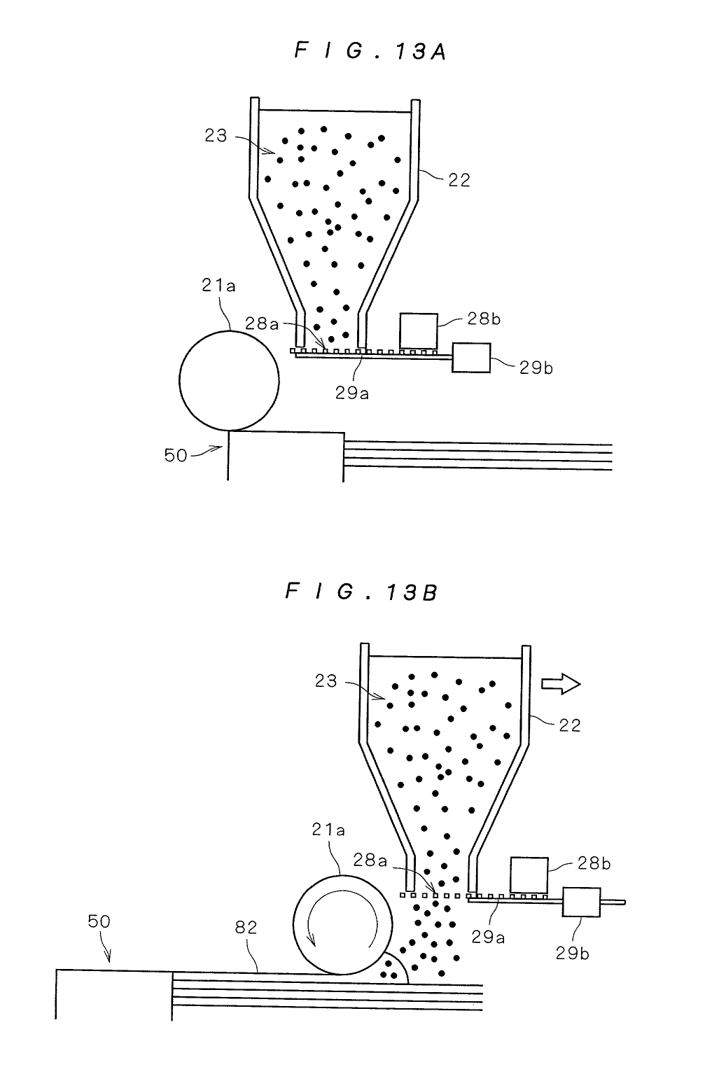

For that reason, it is desirable to make a configuration such that vibrations are transferred only to the plate 28a, not to the other parts of the powder supply mechanism 22. FIGS. 13A and 13B show the powder supply mechanism 22 of such a configuration as to vibrate only the plate 28a. As shown in FIG. 13A, the mesh plate 28a with a plurality of holes is provided on the bottom surface side of the powder reservoir 23 in the powder supply mechanism 22 and the retractable shutter 29a is provided in the lower part of the plate 28a. The vibration generating mechanism 28b for vibrating the plate 28a is located in direct contact with the plate 28a.

For powder supply, as shown in FIG. 13B, the shutter driver 29b drives the shutter 29a to open the bottom surface side of the powder reservoir 23 and the vibration generating mechanism 28b operates to transmit vibrations directly to the mesh plate 28a. As a result, even if the vibration generating mechanism 28b operates, no vibration is given to the other parts of the powder supply mechanism 22. This prevents absorption of vibrations of the plate 28a, thereby permitting a more proper supply of powder material.

<5. Modifications>

While several preferred embodiments of the preferred embodiments have been described, it is to be understood that the present invention is not limited to those described in the aforementioned preferred embodiments.

For example, while in the aforementioned preferred embodiments the powder spreader mechanism for spreading a powder material supplied from the powder supply mechanism is constituted by a spreader roller, it is not limited thereto but may be constituted by a blade member which can reciprocate along the X direction. If the powder spreader mechanism is constituted by a blade member, it becomes possible to eliminate the drive mechanism, the powder removal member, and the like. This simplifies the configuration of the apparatus.

While the above preferred embodiments have illustrated the cases where the powder supply mechanism provides a continuous supply of powder material along the X direction, the supply of powder material needs not to be continuous but may occur intermittently along the X direction. Even in such a case, it is possible to form a powder layer of a more uniform thickness than when spreading all the amounts of powder material which is necessary for formation of a single layer over the whole surface of the stage from the end of the modeling section as in the conventional apparatus.

While the aforementioned preferred embodiments provide examples of configurations which enable coloring of the surface of a 3D object, it is without saying that the features of the present invention are also adaptable to other 3D modeling apparatuses which reproduce only the shape of a 3D object without coloring.

While the invention has been shown and described in detail, the foregoing description is in all aspects illustrative and not restrictive. It is therefore understood that numerous modifications and variations can be devised without departing from the scope of the invention.

What is claimed is:

1. A three-dimensional modeling apparatus for fabricating a three-dimensional object by applying a binding material to a powder material to bind said powder material thereby to form bodies of bound powder material in sequence,
said apparatus comprising:
a powder spreader mechanism being movable toward a predetermined travel direction for spreading said powder material along said travel direction to form a layer of said powder material; and
a powder supply mechanism moving along said travel direction for supplying said powder material ahead of said powder spreader mechanism along said travel direction.

2. The apparatus according to claim 1, wherein
said powder supply mechanism provides a continuous supply of said powder material along said travel direction.

3. The apparatus according to claim 1, wherein
said powder supply mechanism supplies a predetermined amount of said powder material by rotating a roller which is located on the lower side of a powder reservoir, having a number of holes on the surface.

4. The apparatus according to claim 1, wherein
said powder supply mechanism supplies a predetermined amount of said powder material by vibrating a mesh plate which is located on the bottom surface side of a powder reservoir, having a plurality of holes.

5. The apparatus according to claim 1, wherein
said powder spreader mechanism and said powder supply mechanism move as a unit.

6. The apparatus according to claim 1, wherein
said powder spreader mechanism and said powder supply mechanism are driven by the same driving source in said travel direction.

7. The apparatus according to claim 1, wherein
said powder supply mechanism is configured to spread said powder material along said travel direction by moving a roller toward said travel direction while at the same time, rotating said roller in a predetermined direction, thereby to form a layer of said powder material,
said apparatus further comprising:
a powder removal member for removing powder adhering to the surface of said roller.

8. A three-dimensional modeling apparatus for fabricating a three-dimensional object by applying a binding material to a powder material to bind said powder material thereby to form bodies of bound powder material in sequence,
said apparatus comprising:
a powder spreader mechanism being reciprocally movable along a predetermined travel direction for spreading said powder material along said travel direction to form a layer of said powder material; and
a powder supply mechanism for supplying said powder material ahead of said powder spreader mechanism along either direction of reciprocating movement of said powder spreader mechanism.

9. The apparatus according to claim 8, wherein
said powder spreader mechanism includes:
a first spreader member for spreading said powder material when moving toward a first direction, to form a layer of said powder material; and
a second spreader member for spreading said powder material when moving toward a second direction opposite from said first direction, to form a layer of said powder material, and
said powder supply mechanism is located between said first spreader member and said second spreader member for supplying said powder material ahead of either said first or said second spreader member when said powder spreader mechanism moves in either said first or said second direction.

10. A three-dimensional modeling apparatus for fabricating a three-dimensional object by applying a binding material to a powder material to bind said powder material thereby to form bodies of bound powder material in sequence,
said apparatus comprising:
a powder spreader mechanism being movable toward a predetermined travel direction for spreading said powder material along said travel direction to form a layer of said powder material;
a powder supply mechanism for supplying said powder material ahead of said powder spreader mechanism along said travel direction; and
a powder supply varying member for varying a supply of said powder material from said powder supply mechanism according to a thickness of said layer formed by said powder spreader mechanism.

11. A three-dimensional modeling apparatus for fabricating a three-dimensional object by applying a binding material to a powder material to bind said powder material thereby to form bodies of bound powder material in sequence,
said apparatus comprising:
a powder spreader mechanism for spreading said powder material along a predetermined travel direction by moving a roller toward said travel direction while at the same time, rotating said roller in a predetermined direction, thereby to form a layer of said powder material; and
a powder removal member for removing powder adhering to the surface of said roller.

12. The apparatus according to claim 11, wherein
said roller is configured to transmit a driving force from a drive mechanism for moving said powder spreader mechanism in said travel direction, said roller being rotated in a predetermined direction by said driving force.

13. A three-dimensional modeling apparatus for fabricating a three-dimensional object from a powder material and a binding material, comprising:
a powder supply mechanism for supplying said powder material to form a layer of said powder material in a predetermined modeling space:
a smoothing member for smoothing out said powder material supplied from said powder supply mechanism;
a first drive mechanism for driving said powder supply mechanism to scan a plane in said modeling space;
a second drive mechanism for driving said smoothing member to scan said plane, following after said powder supply mechanism driven by said first drive mechanism;
a binder supply mechanism for supplying said binding material onto said powder material smoothed, to represent a section of said three-dimensional object in said plane, following after said smoothing member driven by said second drive mechanism; and
a controller for controlling said first drive mechanism, said second drive mechanism, and said binding material supply mechanism to repeat a drive and a supply a required number of times, to generate said three-dimensional object from said powder material bound with said binding material in said modeling space.

14. The apparatus according to claim 13, wherein
said powder supply mechanism provides a continuous supply of said powder material in said modeling space when driven by said first drive mechanism to scan said plane.

15. The apparatus according to claim 13, wherein
said smoothing member is a roller which is driven by said second drive mechanism to rotate in a predetermined direction.

16. The apparatus according to claim 13, wherein
said powder supply mechanism and said smoothing member are driven as a unit.

17. A three-dimensional modeling method for fabricating a three-dimensional object from a powder material bound with a binding material in a stepwise fashion,
said method comprising:
a first step of forming a layer of said powder material; and
a second step of selectively supplying said binding material to said layer of said powder material,
said first and second steps being repeatedly performed to fabricate said three-dimensional object,
said first step including the steps of:
supplying said powder material onto a previously-formed layer of said powder material while scanning said previously-formed layer; and
smoothing out said powder material supplied, to form a layer of said powder material.
